(19) United States
(12) Patent Application Publication
(10) Pub. No.: US 2012/0064406 A1
(43) Pub. Date: Mar. 15, 2012

(54) ELECTRODE MATERIAL, METHOD FOR PRODUCING SAME, AND LITHIUM ION SECONDARY BATTERY

(75) Inventors: Hiroshi Sato, Niigata (JP); Takayuki Fujita, Niigata (JP)

(73) Assignee: NAMICS CORPORATION, Niigata (JP)

(21) Appl. No.: 13/262,199

(22) PCT Filed: Mar. 24, 2007
(86) PCT No.: PCT/JP2010/055025

§ 371 Date: Nov. 23, 2011

(30) Foreign Application Priority Data
Apr. 1, 2009 (JP) 2009-089420

(51) Int. Cl. H01M 4/60; B05D 3/02; H01M 4/54; B05D 5/12; H01M 4/48; H01M 4/52

(52) U.S. Cl. 429/213; 429/218.1; 429/223; 429/220; 429/219; 429/231; 429/231.5; 429/221; 427/123

(57) ABSTRACT

Secondary batteries for automobiles require good input/output characteristics and low internal resistance. Conventionally, the surface of an active material is coated with metal particles to reduce the internal resistance of a battery, but without achieving remarkable improvement in the conductivity of the active material or decreasing the internal resistance of the battery since an oxide film is formed on the metal particle surfaces. The present electrode material is produced by mixing and dispersing an active material and a metal source compound, then depositing metal particles on the surface of the active material by thermal decomposition, vapor phase reduction, liquid phase reduction or a chemical reaction combining any of these. Since an oxide film is not formed on the metal particles, an electrode material having high conductivity is obtained. The electrode material decreases the internal resistance of a battery and improves the input/output characteristics of a battery.

### TECHNICAL FIELD

The present invention relates to an electrode material and a method for producing the same, and particularly, an electrode material preferably used in a lithium ion secondary battery and a method for producing the same.

### BACKGROUND ART

In recent years, development of a hybrid car has progressed as an environmentally-friendly automobile. On the other hand, a nonaqueous lithium ion secondary battery has characteristics of high energy density, from which a high voltage exceeding the electrolysis voltage of water can be obtained. Due to having such characteristics, utilization of a lithium ion secondary battery in a hybrid car has been studied. However, a lithium ion secondary battery conventionally contains an active substance with low conductivity, which constitutes an electrode, and thus has a defect of high internal resistance. As a trial of reducing internal resistance of a lithium ion secondary battery, a method for mixing an auxiliary conductive material such as carbon in an active substance is disclosed (Patent Document 1). However, for driving a hybrid car with a battery, a secondary battery having extremely preferable input/output characteristics, that is, low internal resistance has been required in order to respond motor driving at start, recovery of regenerating energy at stop, and high input/output load at start-up of power tools. Conventional batteries using carbon as an auxiliary conductive material could not respond to these demands. When a large input/output load is given to a secondary battery having high internal resistance, most of energy is consumed for heat generation of the battery, and energy efficiency is thus poor. In a nonaqueous battery, an internal pressure increases due to heat generation, and thus, it has been necessary to suppress internal resistance of the battery as low as possible in view of not only energy efficiency but also safety.

Patent Document 2 discloses a technique of securing conductivity of an active substance by coating metal material particles with a particle size of 0.005 μm to 10 μm on the surface of the electrode active substance. Patent Document 2 describes an example in which titanium and aluminum are used as metal material particles. These metal fine particles have extremely high surface activity and there is a possibility of dust explosion by radical oxidation, thus being difficult in handling in the fine particle state. However, in Patent Document 2, “application” is exemplified for a method for coating metal material particles (paragraph [0024]), but there is no description about a specific method thereof. For example, Patent Document 2 does not describe how to handle metal fine particles having high activity safely without causing dust explosion. Therefore, it is not recognized that Patent Document 2 discloses the invention sufficiently enough to be easily reproduced by a person skilled in the art. What is more, the coating method described in Patent Document 2 is adhering metal particles on an active substance by a physical method which is not accompanied by a chemical reaction. Therefore, surfaces of these metal fine particles are generally formed from layers of thin oxide films. An oxide film of titanium or aluminum, which is a metal particle exemplified in Patent Document 2, is hard to be a metal by reduction using chemical agents or gas such as hydrogen due to the properties of the elements, and is generally a semiconductor or an insulator. Accordingly, even if metal particles are coated on an active substance in the method of Patent Document 2, in actuality, it is difficult to obtain conductivity similar to metals. Further, Patent Document 2 describes that a method such as atmospheric plasma can also be used as a method for coating metal material particles (paragraph [0009]). However, as described in the paragraph [0011], since CVD and PVD are described as conventional methods with defects, the method such as atmospheric plasma is hardly considered to be plasma CVD and thus unclear with respect to how to specifically use plasma.

### PRIOR ART DOCUMENTS

### Patent Documents

Patent Document 1: Japanese Unexamined Patent Application Publication (JP-A) No. 2008-112594
Patent Document 2: JP-A No. 11-250896
Patent Document 3: JP-A No. 11-297311
Patent Document 4: JP-A No. 2003-192327
Patent Document 5: JP-A No. 2006-261020

### DISCLOSURE OF INVENTION

### Problems to be Solved by the Invention

An object of the present invention is to provide a method for producing an electrode material having high conductivity safely, and the electrode material having high conductivity, mainly in order to reduce internal resistance of a lithium ion secondary battery and improve input/output characteristics.

### Means for Solving the Problems

The present invention (1) is an electrode material for a lithium ion secondary battery obtained by depositing a metal generated from a metal source compound by thermal decomposition and/or reduction on an active substance.

The present invention (2) is the electrode material according to the invention (1), wherein the metal deposits on the active substance in a state that the active substance and the metal are in contact without interposition of an oxide therebetween.

The present invention (3) is the electrode material according to the invention (1) or (2), wherein the metal source compound is any one of an organic metal compound, an organic metal complex, a metal compound containing a carbonate radical, a metal hydroxide, and a metal hydroxide peroxide, or a substance obtained by combining the compounds.

The present invention (4) is the electrode material according to one of the inventions (1) to (3), wherein the metal is any one of nickel, copper, platinum, paradigm, silver, zinc, cobalt, vanadium, tungsten, molybdenum, chromium, and iron, or a mixed material or a metal alloy thereof.

The present invention (5) is an active substance paste for a battery formed by mixing and dispersing at least an electrode material according to one of the inventions (1) to (4) and a vehicle.

The present invention (6) is a wet type or all solid-state lithium ion secondary battery formed using the active substance paste for a battery according to the invention (5).

The present invention (7) is a method for producing an electrode material, including at least a step of producing primary powder by mixing and dispersing an active substance and a metal source compound, and a step of producing an electrode material by generating a metal from the metal source compound by thermal decomposition of the primary powder and depositing the metal on the active substance.

The present invention (8) is a method for producing an electrode material, including at least a step of producing primary powder by mixing and dispersing at least an active substance and a metal source compound, and a step of producing an electrode material by generating a metal from the metal source compound by vapor phase reduction of the primary powder and depositing the metal on the active substance.

The present invention (9) is a method for producing an electrode material, including at least a step of producing primary powder by mixing and dispersing an active substance and a metal source compound, a step of producing secondary powder by thermal decomposition of the primary powder, and a step of producing an electrode material by generating a metal from the metal source compound by vapor phase reduction of the secondary particles and depositing the metal on the active substance.

The present invention (10) is the method for producing an electrode material according to one of the inventions (7) to (9), wherein the metal source compound is anyone of an organic metal compound, an organic metal complex, a metal compound containing a carbonate radical, a metal hydroxide, and a metal hydroxide peroxide, or a substance obtained by combining the compounds.

The present invention (11) is the method for producing an electrode material according to one of the inventions (7) to (10), wherein the metal comprises any one of nickel, copper, platinum, paradigm, silver, zinc, cobalt, vanadium, tungsten, molybdenum, chromium, and iron, or a mixed material or a metal alloy thereof.

### Effect of the Invention

According to the present inventions (1) to (4), production of an electrode material for a lithium ion secondary battery having high conductivity can be possible.

According to the present inventions (5) and (6), use of an electrode material having high conductivity makes it possible to produce a lithium ion secondary battery having low internal resistance and excellent input/output characteristics.

According to the present inventions (7) to (11), production of an electrode material for a lithium ion secondary battery having high conductivity by a production process with high operational safety at low cost can be possible.

### BRIEF DESCRIPTION OF DRAWINGS

FIG. 1 is a cross-sectional view of the order of steps to describe a preferable embodiment of the method for depositing metal particles of the present invention.

FIG. 2 is XRD measurement data of a sample obtained by depositing nickel particles on an active substance.

FIG. 3 is XRD measurement data of a sample obtained by depositing copper particles on an active substance.

FIG. 4 is a pattern cross-sectional view of an active substance having conventional metal material particles.

### EXPLANATION OF SYMBOLS

1 Active substance
2 Metal source compound
3 Active substance particles
4 Metal source compound particles
5 Metal particles
6 Metal oxide particles
101 Electrode active substance
102 Coated particles

### MODE FOR CARRYING OUT THE INVENTION

Preferable embodiments of the present invention will be described in the following.

The inventors of the present application investigated a cause of not obtaining a remarkable effect on improvement in conductivity even when metal particles are coated on the surface of an active substance in the method described in Patent Document 2. As a result, they found that the reason is because when metal particles are coated in a physical method, for example, a metal oxide is formed in a reaction with oxygen in the atmosphere, and thus, the active substance and the metal particles are in contact with interposition of the metal oxide having low conductivity. Based on this finding, the inventors made intensive studies; as a result, they found that by a chemical method in which an active substance and a metal source compound are mixed and dispersed and then decomposed or reduced to thus deposit metal particles from the metal source compound on the surface of the active substance, an electrode material having high conductivity can be produced without forming an oxide.

In addition to not forming an oxide, the method for producing an electrode material of the present invention is a useful production method having excellent characteristics in terms of the following items (2) to (5).
(1) Generated products having low conductivity such as an oxide are not formed.
(2) An active substance is not decomposed or denatured in a reaction of depositing metal particles.
(3) Generated products having high risks such as toxicity and explosibility are not formed.
(4) High cost processes such as a specific high-temperature treatment and use of a vacuum equipment are not employed and thus a production cost is low.
(5) In a reaction of depositing metal particles, a metal or an active substance is not coagulated and a state of appropriate dispersion and mixing is maintained.

In the method for producing an electrode material of the present invention, any one of an organic metal compound, an organic metal complex, a metal compound containing a carbonate radical, a metal hydroxide, and a metal hydroxide peroxide, or a substance obtained by combining the compounds is preferably used as the above described metal source compound. For a method of the above described decomposition or reduction, any of thermal decomposition, vapor phase reduction, and liquid phase reduction, or a method combining the above methods is preferably used. The inventors of the present application found that use of these materials and treating in these methods enable effective deposition of metal particles on the surface of an active substance, which, as a result, makes it possible to smooth provision of electrons to the active substance and discharge of electrons from the active substance, and input/output characteristics of a lithium ion secondary battery constituted with the active substance thus obtained can be improved, and they achieved completion of the present invention. In a method for mixing and contacting auxiliary conductive powder such as carbon with an active substance, or coating metal particles, as shown in conventional techniques, the active substance and the auxiliary conductive powder can secure conductivity only by point contact; on the contrary, according to the present invention, deposition of metal particles on the surface of an active substance is performed by a chemical deposition method; therefore, contact areas of the active substance and the metal particles increase and higher conductivity can be thus realized.

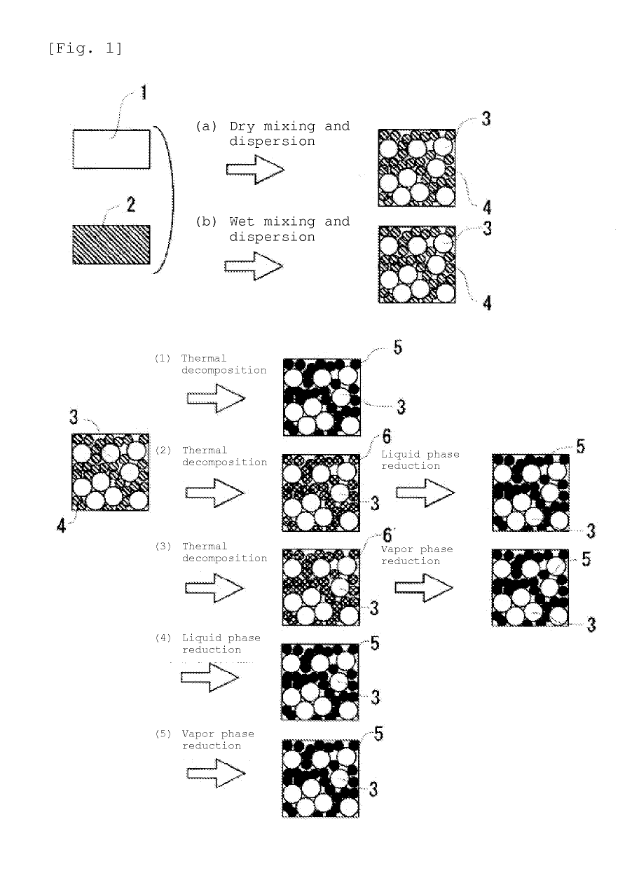

As the method for producing an electrode material of the present invention, preferable embodiments include methods described below. FIG. 1 is a cross-sectional view of the order of steps to describe a preferable embodiment of the method for depositing metal particles of the present invention.
(1) A method in which active substance powder 3 and a metal source compound 4 are mixed and dispersed in (a) a dry method or (b) a wet method, and the obtained powder is heated at a higher temperature than the thermal decomposition temperature of the metal source compound 4 and fractured to thus obtain predetermined powder.
(2) A method in which active substance powder 3 and a metal source compound 4 are mixed and dispersed in (a) a dry method or (b) a wet method, and the obtained powder is heated at a higher temperature than the thermal decomposition temperature of the metal source compound 4 and fractured, thereafter further performing liquid phase reduction in the case of forming a metal oxide 6 to thus obtain predetermined powder.
(3) A method in which active substance powder 3 and a metal source compound 4 are mixed and dispersed in (a) a dry method or (b) a wet method, and the obtained powder is heated at a higher temperature than the thermal decomposition temperature of the metal source compound 4 and fractured, thereafter further performing vapor phase reduction in the case of forming a metal oxide 6 to thus obtain predetermined powder.
(4) A method in which active substance powder 3 and a metal source compound 4 are mixed and dispersed in (a) a dry method or (b) a wet method, and the obtained powder is subjected to liquid phase reduction to thus obtain predetermined powder.
(5) A method in which active substance powder 3 and a metal source compound 4 are mixed and dispersed in (a) a dry method or (b) a wet method, and the obtained powder is subjected to vapor phase reduction to thus obtain predetermined powder.

### (Metal Source Compound Material)

For metals constituting the electrode material of the present invention, metal elements having higher electron conductivity are preferably used as compared to electron conductivity of carbon particles. For a metal source compound that deposits such metals, organic metal compounds are preferably used. Specifically, examples include organic acid metal compounds such as silver acetate, copper acetate, copper formate, nickel acetate, copper acetate, zinc acetate, zinc formate, cobalt acetate and iron acetate; an ethylenediaminetetraacetic acid (EDTA) metal complex, an acetyl acetonate complex, and metal soaps.

For the metal source compound described above, a metal compound containing a carbonate radical, a metal hydroxide, and a metal hydroxide peroxide can also be used instead of organic metal compounds. Specifically, examples include silver carbonate, basic nickel carbonate, and basic copper carbonate. Metal carbonate and organic metal complexes, and basic metal compounds generate gas in thermal decomposition and reduction and the gas does not have toxicity such as water, oxygen and carbon dioxide gas, and the metal carbonate and organic metal complexes, and basic metal compounds are preferable from the viewpoint of safety of handling operation for carrying out the present invention.

The above described metal source compounds can be used by mixing with one or more metal compounds. For example, when an active substance, and nickel acetate and copper acetate are appropriately mixed and dispersed and the resultant is thermally decomposed in a reduction atmosphere and an inert gas atmosphere, the metals of nickel and copper can be simultaneously deposited on the surface of the active substance, and an alloy can also be formed. Controlling ratios in use of plural kinds of metals to be deposited and a thermal decomposition temperature enables battery design with flexibility in crystal diameters and particle diameters of the metal species to be deposited, electrical conductivity, and battery characteristics.

For the metals to be deposited, one of nickel, copper, platinum, paradigm, silver, zinc, cobalt, vanadium, tungsten, molybdenum, chromium, and iron, or a mixed material or a metal alloy thereof is preferably used.

For an organic metal compound that is to be the metal source, a substance with a small molecular weight is preferably used. For example, the order of more preferable organic metal compounds is metal formate>metal acetate>metal oxalate>metal soaps. The reasons thereof are because when an organic substance bonding to a metal has a small molecular weight, a decomposition temperature is low, and there are advantages such that 1. an energy cost for a production process can be suppressed, 2. a metal content per unit weight becomes large, 3. thermal damage is not given to an active substance, and 4. a metal source compound hardly causes a reaction with an active substance in the middle of thermal decomposition. Contents of experiments leading to this finding will be shown below.
(1) Firstly, LiMn₂O₄ and iron oxalate were mixed and the mixture was subjected to thermal decomposition with a reduction gas at 500° C. to deposit a metal, resulting in that LiMn₂O₄ itself was reduced to brake the structure, and at the same time, iron oxalate was remained as iron oxide, and a peak that is supposed to be an iron and lithium complex oxide appeared by XRD (X-ray diffraction structural analysis.)
(2) Then, when copper formate and LiMn₂O₄ were combined and the mixture was treated with a reduction gas, although a peak of metal copper was confirmed by XRD, structural change in LiMn₂O₄ was observed as was expected.
(3) When a mixture of LiMn₂O₄ and copper formate was subjected to thermal decomposition in the atmosphere in order to suppress structural change in LiMn₂O₄, copper oxide (CuO) was generated while keeping the structure of LiMn₂O₄. Then, a further treatment with a reduction gas resulted in that metal copper was deposited but the structure of LiMn₂O₄ was changed.
(4) When LiMn₂O₄ and copper formate were mixed and treated at 300° C. in a nitrogen atmosphere, LiMn₂O₄ and metal copper were generated. No change occurred in the structure of LiMn₂O₄ (the process conditions and evaluation data in this time are described in examples as Example 1B.)

The followings can be found from the above description.
(1) In the case of using an active substance that is reduced in reduction gas atmosphere and easily changes the structure, a metal source compound that is thermally decomposed at a low temperature (for example, metal formate) is used, as well as lowering a treating temperature, an inert gas such as a nitrogen gas, not a reduction gas, is preferably used for a thermal decomposition atmosphere.
(2) A metal source compound which does not react with an active substance at a treating temperature is selected.

### (Active Substance Material)

Materials of an active substance, which can be preferably used for the electrode material of the present invention, are not limited to specific substances, and any substance can be preferably used as long as the materials are substances having discharge and storage ability of a lithium ion. Among these substances, a substance having an electric potential occurring discharge and storage of a lithium ion in the noble side is the positive electrode, and a substance having an electric potential occurring discharge and storage of a lithium ion in the base side is the negative electrode. When a voltage more than difference in electric potentials of the positive electrode-negative electrodes is impressed to the positive electrode by external electoral power based on the negative electrode, it is a condition for expressing battery functions that the positive electrode is a lithium ion donor, and the negative electrode is a lithium ion acceptor. Among active substances applicable to the present invention, examples of the lithium ion donor include complex oxides, complex sulfates, complex nitrides, and fluoride oxides, which are constituted with lithium and one or more metals. Examples of the lithium ion acceptor include metal oxides, metal sulfates, and metal nitride, which are constituted with one or more metals, complex oxides, complex nitrides, and complex sulfates, which are constituted with lithium and one or more metals, phosphorus sulfide compounds, carbon, and metal alloys. Specifically, examples include LiCoO₂, LiNiO₂, LiMnO₂, LiMn₂O₄, LiCuO₂, LiCoVO₃, LiMnCoO₄, LiMnCrO₄, LiCoPO₄, Li₂CoPO₄F, Li₂CoSiO₄, LiFePO₄, Li_{4/3}Ti_{5/3}O₄, LiTiO₂, LiM1ₛM2ₜOᵤ (M1 and M2 are transfer metals, and s, t and u are arbitrary positive numbers), MoS₂, TiS₂, MnO₂, NiPS₃, a lithium-aluminum alloy, high graphitized soft carbon, low graphitized soft carbon, low-temperature calcinated carbon, and hard carbon.

### (Preferable Combination of Active Substance and Metal Source Compound)

### (When an Active Substance is LiMn₂O₄)

When an active substance is LiMn₂O₄, the structure of the active substance is easily changed as described above. Therefore, a metal source compound having a small molecular weight, for example, formic acid metal, is used, and a low-temperature heat treatment is preferably performed in an inert gas atmosphere.

### (When an Active Substance is LiCoO₂)

When an active substance is LiCoO₂, Cu can be used as the metal species of a metal source compound. Since LiCoO₂ and Cu are hardly reacted, even when, for example, LiCoO₂ and copper formate are mixed and the mixture is subjected to thermal decomposition, copper oxide and metal copper generated by the decomposition hardly cause an unnecessary reaction with LiCoO₂.

Ni can also be used as the metal species. Since LiNiO₂ is a positive electrode active substance, in the case of synthesis of a positive electrode material, for example, even when LiCoO₂ and nickel formate are combined to be treated, LiCo₍₁₋ₓ₎NiₓO₂ that is possibly generated is also a positive electrode active substance, and thus, there is no fear to degrade characteristics of a battery.

As a matter of course, use of Co as the metal species is not a problem. Even if an exchange reaction of deposition metal Co with Co in LiCoO₂ occurs, there is no fear to arise a problem.

### (When an Active Substance is Li₄Ti₅O₁₂)

Li₄Ti₅O₁₂ that is not easily changed in the structure even with a heat treatment in a reduction gas atmosphere can select a broad range of substances as a metal source compound. For the metal species of the metal source compound, examples such as Ni, Cu, and Co can be selected.

### (Specific Example of Production Method)

### (Mixing and Dispersion)

The electrode material according to the present invention is made of an active substance on which metal particles are deposited on the surface thereof. Such an electrode material is generally made of an active substance and a metal source compound, which are processed into a powdered state as raw materials, and firstly, these raw materials are uniformly dispersed to be mixed in either method for dry mixing and dispersion or wet mixing and dispersion. Initial raw materials are not necessarily processed into a powdered state, but may be in a balky state, or an aggregated state. Even in such cases, the raw materials are crushed in the mixing and dispersion step to be processed into a powdered state. The dry mixing and dispersion is a method for mixing and dispersing without using a liquid, and for example, the raw materials can be processed using devices such as a vibration mill, a planetary boll mill, and a pot mill.

The wet mixing and dispersion is a method for mixing and dispersing in which powder that is a raw material is mixed with a liquid to form a slurry and processed and, for example, the slurry can be processed using a device such as a bead mill. A bead mill is a device filled with crushing media called beads in a rotation container called a crushing room. The slurry is sent into the crushing room with a pump and beads are collided with the slurry to thus finely crush and disperse raw materials. Finally, the slurry and the beads are separated by a centrifugal device and a screen which are located at the outlet of the crushing room.

For determining which method of the dry mixing and dispersing or the wet mixing and dispersing is used, an appropriate method may be used according to kinds of raw materials to be used. A method other than the dry mixing and dispersing and the wet mixing and dispersing can be used. In the case of using any of the methods, it is preferable to use a method capable of controlling a concentration of a metal source compound surrounding active substance powder within an appropriate range. The concentration range of the metal source compound preferably appropriately set within an optimal range according to a purpose of use of a battery, an active substance material, and a metal source compound material. For example, secondary batteries used for a calculator and an alarm display light on a road, which are equipped with solar batteries, have approximately constant power consumption and priority of high output characteristics is low. Therefore, for example, priority is given to a battery capacity and the like, and a battery is designed to increase an amount of an active substance. On the other hand, output characteristics are emphasized in a secondary battery for a hybrid car, and thus, a battery is designed to have a higher concentration of a metal source compound.

In the case of a wet type battery, a minimum concentration of a deposition metal is set so that electrical resistance between the active substance in the electrode and the collector electrode can be effectively reduced, and a maximum concentration of the deposition metal is set to the level of not inhibiting transfer of a lithium ion between the active substance in the electrode and an electrolyte layer, and a concentration of a metal source compound is preferably set within the ranges.

In the case of an all solid-state battery, it is necessary that, after one-time firing, a deposition metal is connected to the collector electrode with keeping continuity, and an active substance is connected to a solid electrolyte layer with keeping continuity, and the concentration of the metal source compound is preferably set to 30 to 70 vol % in the range that particles can retain continuity in three dimensions in consideration of the percolation theory.

### (Method for Treating Particles Obtained by Dry Mixing and Dispersion)

It is preferable that powder obtained from an active substance and a metal source compound by dry mixing and dispersion are heated at a higher temperature than the thermal decomposition temperature of the metal source compound in the atmosphere as being the powder or after forming into a molded article, thereby depositing a metal or a metal oxide on the surface of the active substance. Reduction in a production cost is possible by treating in the atmosphere.

When a metal oxide is generated by performing thermal decomposition in the atmosphere, thermal decomposition may be performed in an inert gas atmosphere, or after performing thermal decomposition in the atmosphere, liquid phase reduction or vapor phase reduction may be carried out to reduce the metal oxide and deposit a metal. Additionally, thermal decomposition is not performed, and powder obtained in mixing and dispersion or a molded article formed from the powder may be directly subjected to liquid phase reduction or vapor phase reduction to deposit metal particles.

### (Method for Treating Powder Obtained by Wet Mixing and Dispersion)

A slurry obtained by wet mixing and dispersion of an active substance and a metal source compound is dried to evaporate a solvent and the dried product is fractured and powdered, and then the powder is subjected to a heat treatment and a reduction treatment in the same manner as in the case of the above described dry mixing and dispersion to thus obtain deposition of metal particles. Examples of an equipment used in drying the slurry include a slurry dryer, a spray dryer, a band dryer, and a batch dryer. A metal source compound is desirably dried with keeping high dispersibility, and a spray dryer is preferably used. The drying step may double with a thermal decomposition step, and by setting a drying temperature by the dryer as described above at a higher temperature than the thermal decomposition temperature of the metal source compound, deposition of metal particles can be obtained.

### (Specific Method of Vapor Phase Reduction)

Vapor phase reduction can be carried out by a heat treatment in a reductive gas atmosphere such as hydrogen. A heat treatment temperature and time may be suitably set depending on materials of an active substance and a metal source compound to be treated.

### (Addition of Fusing Agent)

It is preferable to add a fusing agent for the purpose of promoting flowability of the surface of an active substance in mixing and dispersing the active substance and a metal source compound by the above technique. Due to promotion of the surface flowability of the active substance in the thermal decomposition step, bond of the active substance and a deposited metal or a deposited metal oxide is more potent, and as a result, a contact area between these deposited products and the active substance increases and electron conductivity becomes preferable.

### (Thermal Decomposition Temperature)

Determination of an appropriate temperature and heating conditions in the step of depositing a metal or a metal oxide from a mixture of an active substance and a metal source compound by thermal decomposition can be made by a measurement of a heat weight change (TG) of the metal source compound. In order to retain metal particles or metal oxide particles deposited on the surface of the active substance in a state of being uniformly dispersed, thermal decomposition is preferably performed at a temperature as low as possible. Further, the upper limit of the heating temperature can also be determined by a heat weight change, differential calories (TG-DTA) and a temperature increase X-ray diffraction structural analysis of the active substance in the same manner. A temperature at which the active substance is not changed in its structure and lithium diffusion resistance in the active substance does not increase is to be the upper limit of the thermal decomposition.

### (Paste for Battery)

A metal deposited active substance obtained in the present invention is mixed and dispersed with a suitable vehicle, dispersing agent, and the like, to form a paste, and an active substance paste for a lithium ion secondary battery can be prepared. An auxiliary conductive material, a rheology modifier, and the like may be suitably further added according to battery performance to be required.

### (Production of Wet Type Battery)

A method for producing a wet type lithium ion secondary battery will be described below. The paste prepared in the above described method is applied on a collecting electrode foil to prepare an active substance coated foil. Two kinds of active substance coated foils having different lithium ion discharge and storage electric potentials are prepared, a separator for securing electron insulation between these active substance coated foils, and an unwoven fabric for keeping a nonaqueous electrolyte solution on the surface of the active substance are arranged to constitute a lithium ion secondary battery. A metallic foil such as an aluminum foil and a copper foil can be mainly used for the collecting electrode foil. The collecting electrode foil is not limited to these materials, and any metallic foil can be used as long as it is a metallic foil that does not cause chemical change accompanying to a charge and discharge reaction of a battery. For the nonaqueous electrolyte solution and supporting electrolyte, known ones can be used for them. Furthermore, an ambient temperature molten salt (ionic liquid) may be suitably used.

### (Production of All Solid-State Battery)

Next, a method for producing an all solid-state lithium ion secondary battery will be described. A solid electrolyte slip made of fine powder having an atomic skeleton structure capable of diffusing a lithium ion, a binder, a dispersing agent, and a rheology modifier is formed into a thin film on a substrate by the doctor blade method and dried, then the paste prepared in the above described method is applied and printed, and further dried to thus obtain an active substance-coated-solid electrolyte sheet.

For two kinds of active substances having different lithium ion storage and discharge electric potentials, active substance-solid electrolyte sheets are prepared as described above, then laminated alternately and fired at once, thereafter electrically jointing the same active substances to thus constitute a lithium ion secondary battery. In the one-time firing, metallic fine particles deposited on the surface of the active substance are molten so as to fill gaps of adjacent active substance particles, and the metallic fine particles are changed from a scattering particle state to a continuing matrix state. Accordingly, an ideal electron conductive path is formed in the active substance.

A paste to be applied on a solid electrolyte sheet may be applied in plural layers of several kinds of pastes having different ratios of the active substance and the deposited metal. Making layers having different ratios of the active substance and the deposited metal enables forming a more optimal metal matrix structure.

When the all solid-state secondary battery is prepared by one-time firing, it is preferable to select a firing environment according to a metal species that is deposited on the surface of an active substance used in an active substance paste. For example, when a metal that is easily oxidized by heating in the atmosphere is used, it is preferable to perform firing in a nitrogen atmosphere or in a reducing gas atmosphere in order to suppress oxidation in one-time firing.

### (Differences From Similar Conventional Techniques)

Patent Document 2 discloses a technique of further forming a metallic coating film on a coating film of an active substance coated with metallic material particles on the surface thereof by performing electroless plating (paragraph [0012]) or chemical plating (paragraph [0026]). Electroless plating or chemical plating is one kind of liquid phase reduction in a broad sense. However, Patent Document 2 describes that, in general, when the above described metallic coating film is directly formed on an active substance, it is necessary to etch the active substance before formation of the coating film, and, if the coating film is formed, the etching step is unnecessary (paragraph [0012]). On the other hand, when metal particles are deposited on an active substance by liquid phase reduction according to the invention of the present application, an etching treatment is unnecessary. When the etching treatment is performed on the active substance, there is fear that the active substance may be denatured, and it is thus not preferable for production of a battery with high performance. Although differences cannot be clearly referred since there is no detailed description about a specific method for electroless plating and chemical plating in Patent Document 2, etching of an active substance before liquid phase reduction is unnecessary in the method for producing an electrode material of the present invention, and the liquid phase reduction according to the invention of the present application and the electroless plating and the chemical plating described in Patent Document 2 are supposed to be different methods.

Furthermore, it is also described that application of metal particles described in Patent Document 2 is a method carried out instead of etching before formation of the metallic coating film (paragraph [0012]), however, the technique according to the present invention is not a pretreatment before plating to an active substance, and the techniques described in the present invention and Patent Document 2 are different also in this point.

Patent Document 3 describes a nonaqueous secondary battery containing a complex made of silicon powder capable of inserting and discharging a lithium ion to a negative electrode material and a conductive metal imparting conductivity to silicon as a negative electrode active substance. It is described in Patent Document 3 that the conductive metal is obtained by reduction deposition of the conductive metal on silicon with an aqueous solvent (paragraph [0010]). However, an example of liquid phase reduction described in Patent Document 3, copper is deposited by reducing copper sulfate. However, from the viewpoints that, in treating steps, formaldehyde having toxicity is used, and vacuum dry is performed since copper is a substance that is easily oxidized, there are problems with respect to safety and a production cost. On the contrary, the present invention is an excellent technique with high safety and a low production cost as compared to Patent Document 3 in such points.

Patent Document 4 describes a technique of producing a negative electrode active substance made of metal element doped silicon oxide powder by heating silicon oxide and a metal to generate a mixed gas and depositing active substance powder on a cooling substrate. A preferable heating temperature is set from 1100 to 1600° C. The technique described in Patent Document 4 is vaporizing a metal to deposit the metal on an active substance, and the metal is not generated by chemical change such as reduction and decomposition, which is different from the present invention in this point. In addition, the high-temperature heat treatment as described in Patent Document 4 can be applied to a substance such as silicon oxide, which hardly causes thermal decomposition even at a high temperature, but is difficult in applying to a substance with comparatively high volatile such as lithium that is exemplified as a preferable active substance in the present invention. What is more, when a heat treatment is performed at such a high temperature, there is fear to react an active substance and a metal, and also in this respect, the techniques described in the present invention and Patent Document 4 are different.

Patent Document 5 discloses a lithium ion secondary battery provided with an electrode material obtained by forming a transfer metal oxide coating film on a nickel mesh. The nickel mesh functions as a conductive material, and the transfer metal oxide coating film functions as an active substance. Patent Document 5 describes that a transfer metal hydroxide is deposited on the mesh, and then thermally decomposed to form a transfer metal oxide coating film, or the mesh is immersed in an acetic acid metal solution, and then thermally decomposed to form a transfer metal oxide coating film. The structure of the electrode material described in Patent Document 5 is different from the electrode material in the present invention in an arrangement of an active substance and a conductive substance.

When further reduction is performed on the electrode material described in Patent Document 5, the process becomes approximately the same steps as the process according to the present invention, but the structure of the electrode material described in Patent Document 5 is a structure in which a metallic film is formed on a conductive material and thus does not function as an electrode material. Furthermore, the electrode material described in Patent Document 5 is a material with a brittle transfer metal oxide coating film and there is a problem that when the material is tried to be processed after deposition, the transfer metal oxide coating film is peeled off. Therefore, there is a problem that a produced electrode material cannot be formed into a powdered state or a paste state and processed into a molded article for a battery with a different shape and size as the electrode material of the present invention can.

### EXAMPLES

The present invention will be more specifically described with examples below, but the invention is not limited to these examples.

### (Deposition Experiment of Metal Particles)

Firstly, for preparation of a deposition experiment of metal particles, thermal decomposition temperatures of metal source compounds and active substances in various environments were measured using TG-DTA. Nickel acetate, copper acetate, zinc acetate, and silver acetate were used as the metal source compounds, and lithium manganate, lithium cobalt oxide, lithium cobalt phosphate, lithium cobalt silicate, and lithium titanate were used as the active substances. All measurements were performed at a temperature increase rate of 200° C./hr, and weight changes of the samples were measured to be used as a target for determining decomposition temperatures. Then, an experiment of confirming whether metal particles are deposited or not was carried out on these active substances using the deposition method according to the present invention. Nickel acetate, copper acetate, zinc acetate, and silver acetate were used as the metal source compounds, and lithium manganate, lithium cobalt oxide, lithium cobalt phosphate, lithium cobalt silicate, and lithium titanate were used as the active substances. The metal source compound and the active substance were mixed and dispersed in a dry method, then formed into pellets, and heated up to the decomposition temperature determined by the TG-DTA measurement. After heating, the fired substance cooled to room temperature was fractured in wet disruption, thereafter evaluating deposition of metal or metal oxide particles by XRD (X-ray diffraction structural analysis). Further, a state of a desired substance was determined according to presence or absence of structural change in the active substance.

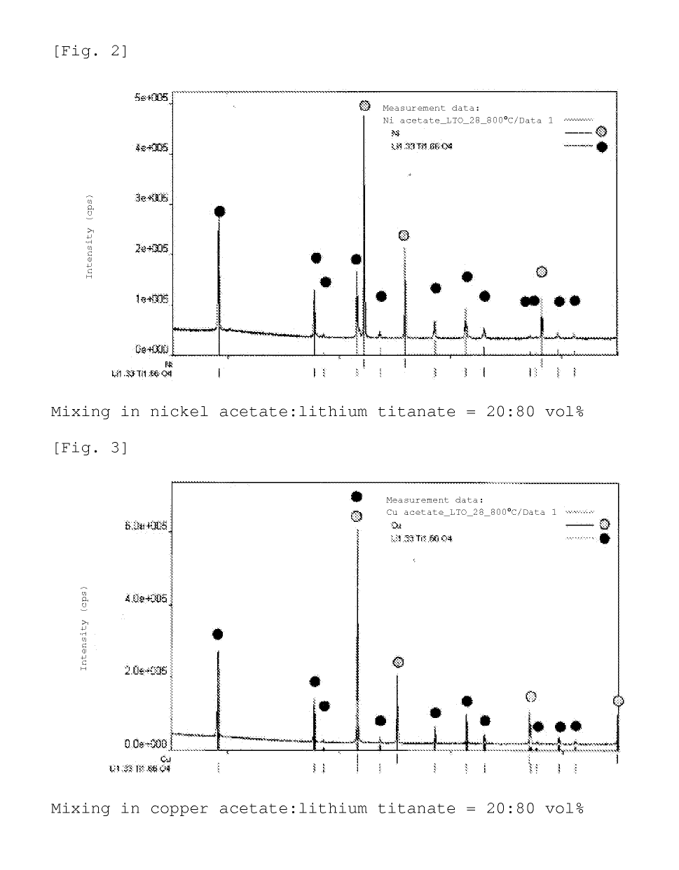

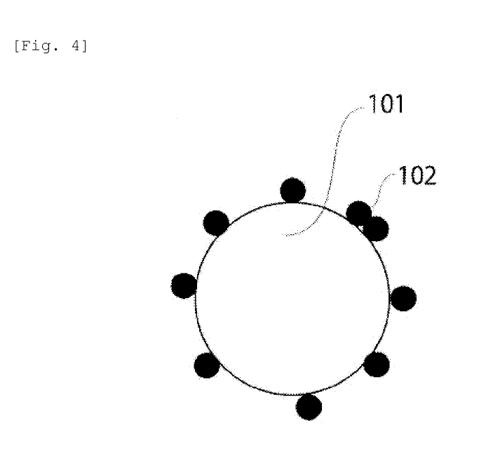

FIG. 2 is XRD measurement data of a sample obtained by mixing an active substance Li_{1.33}Ti_{1.66}O₄ and nickel acetate at 20:80 vol % and heat treating at 800° C. Signal peaks corresponding to nickel and the active substance Li_{1.33}Ti_{1.66}O₄ from the sample were detected, and deposition of metal particles was confirmed. It could be also confirmed that the structure of the active substance was not changed by the heat treatment.

FIG. 3 is XRD measurement data of a sample obtained by mixing an active substance Li_{1.33}Ti_{1.66}O₄ and nickel acetate at 20:80 vol % and heat treating at 800° C. Signal peaks corresponding to copper and the active substance Li_{1.33}Ti_{1.66}O₄ from the sample were detected, and deposition of metal particles was confirmed. It could be also confirmed that the structure of the active substance was not changed by the heat treatment.

### (Preparation of Wet Type Battery and Evaluation of Battery Characteristics)

In order to verify effects of the electrode material subjected to the treatment of the present invention, a lithium ion secondary battery using a treated active substance and a lithium ion secondary battery using an untreated electrode material were prepared and battery characteristics (charge and discharge rate characteristics) were evaluated and compared. Firstly, a wet type battery was prepared and evaluated.

### (Preparation of Electrode Material)

Firstly, an active substance and a metal source compound were mixed. The mixing ratio was set according to a ratio of a volume of a metal after deposition (normal temperature) and the volume of the active substance (normal temperature). Two types of mixing and dispersion methods, dry mixing and dispersion and wet mixing and dispersion, were used depending on materials to be used.

In the case of dry mixing and dispersion, materials were weighed in volume ratios of metal:active substance=5:95 vol % and 20:80 vol %. The weighed materials were mixed and dispersed for 4 hours by a grinding mixer. The obtained mixed powder was molded at an area pressure of 2 t/cm² by a tablet molding machine to obtain a molded article. Further, this molded article was thermally decomposed under predetermined conditions to thus obtain an electrode material made of the active substance on which a metal was deposited on the surface thereof.

A spray dryer was used in wet mixing and dispersion. Firstly, materials were weighed in a volume ratio of matal:active substance=5:95 vol %. Then, a metal source compound was dissolved in anionic exchange water and an active substance powder was dispersed into the solution to prepare an active substance slurry. Next, the obtained slurry was supplied into a spray dryer set at a blast temperature of 230° C., and the ionic exchange water in the slurry was evaporated to dry the slurry. The supply amount of the slurry was set to an amount in which an exhaust air temperature is 90° C. A particle size of the obtained granular material was confirmed to be within the range from about 8 to 20 μm of a median size by an atomizer rotational speed. The obtained mixed powder was molded at an area pressure of 2 t/cm² by a tablet molding machine to obtain a molded article. Further, this molded article was thermally decomposed under predetermined conditions to thus obtain an electrode material made of the active substance on which a metal was deposited on the surface thereof.

Metal deposition was confirmed by XRD, and presence or absence of the structural change in the active substance before and after metal deposition were examined on the obtained electrode materials. Results as well as the details of the preparation conditions were shown in Table 1. It was confirmed from the results that a metal is deposited in any active substance in the examples by thermal decomposition of a metal source compound, and the active substance is not changed in the structure by the thermal decomposition treatment.

Examples 1A, 1B, and 2A shown in Table 1 correspond to methods for depositing a metal by thermal decomposition, and Examples 2B, 3, 4, and 5 correspond to methods for depositing metals by vapor phase reduction. When a metal oxide is formed by thermal decomposition, a metal can be deposited from the metal oxide by carrying out vapor phase reduction after thermal decomposition.

### (Table 1) Electrode Material Preparation Conditions and Results of Structural Analysis

TABLE 1

| | | | | | | Diffractive angles of XRD three | | |
|---|---|---|---|---|---|---|---|---|
| | | | Dispersion | | | strongest lines (20/deg) | | |
| | | Kind of | method of | Thermal | | X-ray wavelength: CuKα | | |
| | Kind of | metal | metal | decomposition | XRD | First | Second | Third |
| | active | source | source | temperature · | identification | strongest | strongest | strongest |
| | substance | compound | compound | atmosphere | results | line | line | line |
| Comparative | LiMn2O4 | None | — | — | LiMn2O4 | 18.66 | 43.92 | 44.39 |
| Example 1 | | | | | | | | |
| Example 1A | | Silver | Spray dry | 500° C. | LiMn2O4 | 18.66 | 44.01 | 44.29 |
| | | acetate + | method | Atmospheric | Silver | 38.12 | 44.29 | 77.40 |
| | | paradigm | | air | Paradigm | 40.11 | 46.65 | 82.10 |
| | | acetate | | | | | | |
| Example 1B | | Copper | Powder | 300° C. | LiMn2O4 | 18.66 | 44.02 | 44.29 |
| | | formate | mixing and | Nitrogen | Copper | 43.38 | 50.53 | 74.24 |
| | | | dispersion | | | | | |
| Comparative | Li4Ti5O12 | None | — | — | Li4Ti5O12 | 18.33 | 43.24 | 35.57 |
| Example 2 | | | | | | | | |
| Example 2A | | Silver | Spray dry | 500° C. | Li4Ti5O12 | 18.37 | 43.25 | 35.59 |
| | | acetate + | method | Atmospheric | Silver | 38.10 | 44.29 | 77.40 |
| | | paradigm | | air | Paradigm | 40.12 | 46.36 | 82.10 |
| | | acetate | | | | | | |
| Example 2B | | Iron | Powder | 500° C. | Li4Ti5O12 | 18.37 | 43.24 | 35.59 |
| | | oxalate | mixing and | Hydrogen · | Iron | 44.45 | 51.81 | 76.36 |
| | | | dispersion | nitrogen | | | | |
| Comparative | LiFePO4 | None | — | — | LiFePO4 | 35.56 | 25.54 | 29.68 |
| Example 3 | | | | | | | | |
| Example 3 | | Nickel | Powder | 500° C. | LiFePO4 | 35.54 | 25.51 | 29.69 |
| | | acetate | mixing and | Hydrogen · | Nickel | 44.45 | 51.81 | 76.36 |
| | | | dispersion | nitrogen | | | | |
| Comparative | LiCoPO4 | None | — | — | LiCoPO4 | 35.93 | 25.70 | 20.81 |
| Example 4 | | | | | | | | |
| Example 4 | | Cobalt | Powder | 500° C. | LiCoPO4 | 35.89 | 25.67 | 20.77 |
| | | acetate | mixing and | Hydrogen · | Cobalt | 44.22 | 51.52 | 75.87 |
| | | | dispersion | nitrogen | | | | |
| Comparative | LiCo0O2 | None | — | — | LiCoO2 | 18.91 | 45.20 | 37.38 |
| Example 5 | | | | | | | | |
| Example 5 | | Basic | Powder | 500° C. | LiCoO2 | 18.90 | 45.20 | 37.38 |
| | | cobalt | mixing and | Hydrogen · | Cobalt | 44.23 | 51.53 | 75.87 |
| | | carbonate | dispersion | nitrogen | | | | |

### (Preparation of Wet Type Battery)

The above described active substance, Ketjen Black, and polyvinylidene fluoride were mixed in a weight ratio of 70:25:5, thereto was further added N-methyl pyrrolidone to form an active substance slip, and then, the active substance slip was uniformly coated on an aluminum foil using a doctor blade and dried. A product obtained by punching out the active substance-coated aluminum sheet with a 14 mmφ-punch (hereinafter, referred to as the “disc sheet electrode”) was vacuum-degassed and dried at 120° C. for 24 hours, and precisely weighed in a glove box at a dew point of −65° C. or less. An aluminum foil disc sheet obtained by punching out only an aluminum sheet with 14 mmφ was also precisely weighed separately, and from the difference from the weighed value of the above described disc sheet electrode, the weight of the active substance applied on the disc sheet electrode was accurately calculated. A wet type battery made of the thus obtain disc sheet electrode, lithium metal, a porous polypropylene separator, an electrolyte retaining sheet made from an unwoven fabric, and an organic electrolyte dissolved with a lithium ion (organic solvent having EC:DEC=1:1 vol dissolved with LiPF6 at 1 mol/L) was prepared.

### (Evaluation of Characteristics of Wet Type Battery)

A charge and discharge experiment was performed at charge and discharge rates of the prepared battery of 0.1 C, 0.2 C, 0.5 C, 1 C, 2 C, and 5 C to measure a charge and discharge capacity per unit weight of the active substance. A value used for comparison examination was calculated from a charge and discharge capacity in the fifth cycle in which battery characteristics are stabilized. Note that similar batteries using an active substance without the treatment of the present invention were prepared and evaluated to be comparative examples. Results are shown in Table 2. It was confirmed from the results that any combination of an active substance and a metal source compound used in the experiment has higher discharge capacity as compared to batteries of comparative examples, and in particular, as a charge and discharge rate becomes higher, more excellent rapid charge and discharge characteristics can be obtained as compared to comparative examples. In the case of dry mixing and dispersion, materials were weighed in volume ratios of metal:active substance=5:95 vol % and 20:80 vol % and a battery was prepared, and approximately equally excellent characteristics were obtained.

### (Table 2) Evaluation of Discharge Capacity of Wet Type Battery

TABLE 2

| | Range of | | | | | | |
|---|---|---|---|---|---|---|---|
| | charge and | | | | | | |
| | discharge | Charge and discharge rate | | | | | |
| | voltage | 0.1 C | 0.2 C | 0.5 C | 1 C | 2 C | 5 C |
| Comparative | 3.0 to 4.3 V | 98 mAh/g | 96 mAh/g | 92 mAh/g | 87 mAh/g | 70 mAh/g | 28 mAh/g |
| Example 1 | | | | | | | |
| Example 1A | | 102 mAh/g | 100 mAh/g | 96 mAh/g | 92 mAh/g | 86 mAh/g | 60 mAh/g |
| Example 1B | | 103 mAh/g | 101 mAh/g | 98 mAh/g | 91 mAh/g | 88 mAh/g | 66 mAh/g |
| Comparative | 0.5 to 2.5 V | 133 mAh/g | 128 mAh/g | 122 mAh/g | 110 mAh/g | 101 mAh/g | 80 mAh/g |
| Example 2 | | | | | | | |
| Example 2A | | 137 mAh/g | 135 mAh/g | 130 mAh/g | 122 mAh/g | 115 mAh/g | 100 mAh/g |
| Example 2B | | 135 mAh/g | 133 mAh/g | 130 mAh/g | 125 mAh/g | 118 mAh/g | 98 mAh/g |
| Comparative | 3.0 to 4.0 V | 140 mAh/g | 131 mAh/g | 122 mAh/g | 110 mAh/g | 97 mAh/g | 72 mAh/g |
| Example 3 | | | | | | | |
| Example 3 | | 149 mAh/g | 146 mAh/g | 140 mAh/g | 134 mAh/g | 127 mAh/g | 98 mAh/g |
| Comparative | 3.5 to 4.8 V | 62 mAh/g | 58 mAh/g | 53 mAh/g | 44 mAh/g | 31 mAh/g | 8 mAh/g |
| Example 4 | | | | | | | |
| Example 4 | | 68 mAh/g | 65 mAh/g | 60 mAh/g | 54 mAh/g | 46 mAh/g | 22 mAh/g |
| Comparative | 3.0 to 4.3 V | 132 mAh/g | 130 mAh/g | 119 mAh/g | 115 mAh/g | 109 mAh/g | 88 mAh/g |
| Example 5 | | | | | | | |
| Example 5 | | 136 mAh/g | 134 mAh/g | 130 mAh/g | 126 mAh/g | 120 mAh/g | 111 mAh/g |

### (Preparation of All Solid-State Battery and Evaluation of Battery Characteristics)

Next, an all solid-state battery using the metal-deposited active substance according to the present invention was prepared and the battery characteristics were evaluated. The all solid-state battery was prepared by performing steps shown below in order:
(a) electrode material preparation step: a step of mixing and dispersing a metal source compound and an active substance, and then thermally decomposing and/or reducing the mixture to obtain a metal-deposited active substance;
(b) battery paste preparation step: a step of obtaining an electrode material paste by kneading and dispersing the metal-deposited active substance, a binder, a solvent, a dispersing agent and the like, a step of obtaining a solid electrolyte paste by kneading and dispersing a solid electrolyte, a binder, a solvent, and a dispersing agent, and the like, and a step of obtaining a collector paste;
(c) printing and lamination step: a step of preparing a lithium ion conductive inorganic substance sheet, printing an extracting electrode paste and the electrode material paste, laminating these sheets, and further providing a protective layer;
(d) firing step: a step of pressure-bonding and firing the above described laminated article; and
(e) extracting electrode formation step.

### (Details of Respective Steps)

### <Electrode Material Preparation Step and Battery Paste Preparation Step>

A metal source compound and an active substance were weighed in a volume ratio defined above of 50:50 vol % and mixed, and the mixture was crushed and dispersed to obtain a mixed powder. The obtained mixed powder was molded at an area pressure of 2 t/cm² by a tablet molding machine to obtain a molded article. Further, this molded article was thermally decomposed under predetermined conditions to thus obtain an electrode material made of the active substance on which a metal is deposited on the surface thereof. 15 parts by weight of ethyl cellulose as a binder and 65 parts by weight of dihydroterpineol as a solvent, and further, particulate boron compound powder were added with respect to 100 parts by weight of the obtained electrode material, and the mixture was kneaded and dispersed with three rolls to prepare an electrode material paste.

For the solid electrolyte, Li_{3.5}Si_{0.5}P_{0.5}O₄ powder with a median size of 0.54 μm was used. 100 parts by weight of ethanol and 200 parts by weight of toluene were added to 100 parts by weight of this powder with a ball mill and wet mixed, and the mixture was then further charged with 16 parts by weight of a poly (vinyl butyral) binder and 4.8 parts by weight of benzylbutyl phthalate and mixed to prepare a solid electrolyte paste.

A collector paste was prepared by adding 15 parts by weight of ethyl cellulose as a binder and 65 parts by weight of dihydroterpineol as a solvent with respect to 100 parts by weight of powder obtained by mixing metal powder and active substance powder in an absolute specific gravity converted volume ratio of 80:20 vol, and the mixture was kneaded and dispersed with three rolls to prepare an electrode material paste.

### <Printing and Lamination Step>

The prepared solid electrolyte paste was formed into a sheet using a PET film as a substrate by the doctor blade method to obtain a lithium ion conductive inorganic substance sheet. The electrode material paste and the collector paste were printed on the opposite side of the PET film of the obtained lithium ion conductive inorganic substance sheet by screen printing, heated at 80 to 100° C. for 5 to 10 minutes, and the paste was dried to obtain an active substance unit sheet on which the electrode material paste was printed on the lithium ion conductive inorganic substance sheet.

Hereinafter, regarding the active substance unit prepared using two different kinds of active substances, an active substance unit in which a storage and discharge electric potential of a lithium ion is noble is referred to as the “positive electrode unit”, and an active substance unit in which a storage and discharge electric potential of a lithium ion is base is referred to as the “negative electrode unit”. Such positive electrode unit and negative electrode unit were prepared and each PET film was peeled off, thereafter laminating alternately so as to be interposed with a lithium ion conductive inorganic substance. In this time, the positive electrode collector was only extended in one end surface, and the negative electrode collector was only extended in the other surface so that the positive electrode unit and the negative electrode unit were shifted and laminated. The laminated article was further sandwiched with a protective layer obtained by overlapping 50 layers of only lithium ion conductive inorganic sheets and molded at a temperature of 80° C. at a pressure of 1000 kgf/cm², and then cut to prepare a laminated block.

### <Firing Step>

The temperature of the obtained laminated block was increased up to 800° C. at a temperature increasing rate of 200° C./hour in the atmosphere, and the laminated block was fired while maintaining the temperature for 8 hours. The laminated block was naturally cooled after firing. A width of each lithium ion conductive organic substance in the thus obtained laminated article after firing was 7 μm, the width of the positive electrode unit was 5 μm, and the width of the negative electrode unit was 6 μm. The length, width and height of the laminated block were 3 mm ×2.1 mm ×0.1 mm, respectively.

### <Extracting Electrode Formation Step>

An extracting electrode paste was applied on an end surface of the laminated article, and thermally cured at 150° C. for 30 minutes. Further, one pair of extracting electrodes was formed to obtain an all solid-state lithium ion secondary battery. For the extracting electrode paste, a thermally curable conductive paste made of silver powder, an epoxy resin, a solvent, and a curing agent was used.

### (Evaluation of Characteristics of All Solid-State Battery)

A charge and discharge experiment was performed at charge and discharge rates of the prepared battery of 0.1 C, 0.2 C, 0.5 C, 1 C, 2 C, and 5 C to measure a charge and discharge capacity per unit weight of the active substance. A value used for comparison examination was calculated from a charge and discharge capacity in the fifth cycle in which battery characteristics are stabilized. Note that similar batteries using active substances without the treatment of the present invention were prepared and evaluated to be comparative examples. Results are shown in Table 3.

In preparation of the all solid-state battery used in the experiment, the conditions of Example 1A in Table 1 were used for preparation of the positive electrode unit, and the conditions of Example 2B in Table 1 were used for preparation of the negative electrode unit.

It was confirmed from the results shown in Table 3 that even in the case of an all solid-state battery, examples of the present invention have higher discharge capacities as compared to batteries of comparative examples, and similar to the case of a wet type battery, as charge and discharge rates become higher, more excellent rapid charge and discharge characteristics can be obtained as compared to comparative examples.

### (Table 3) Evaluation of Discharge Capacity of All Solid-State Battery

TABLE 3

| | Range of | | | | | | |
|---|---|---|---|---|---|---|---|
| | charge and | | | | | | |
| | discharge | Charge and discharge rate | | | | | |
| | voltage | 0.1 C | 0.2 C | 0.5 C | 1 C | 2 C | 5 C |
| Comparative | 0.5 to 4.0 V | 1 | 0.92 | 0.84 | 0.70 | 0.51 | 0.19 |
| Example 6 | | | | | | | |
| Example 6 | | 1.23 | 1.11 | 1.03 | 0.92 | 0.81 | 0.63 |

### INDUSTRIAL APPLICABILITY

As described above, the present invention relates to an electrode material and a battery produced using the electrode material, and a battery having small internal resistance and excellent charge and discharge rate characteristics can be produced. Since high energy efficiency can be obtained and a waste heat amount is less to reduce environmental burdens, in particular, such a battery is effective as a power tool that requires instantaneously large output and has high applicability as a secondary battery for an electric automobile such as, for example, a hybrid car.

1. An electrode material for a lithium ion secondary battery obtained by depositing a metal generated from a metal source compound by thermal decomposition and/or reduction on an active substance, wherein the metal source compound is any one of a metal formate, a metal acetate, a metal compound containing a carbonate radical, a metal hydroxide, and a metal hydroxide peroxide, or a substance obtained by combining the compounds.

2. The electrode material according to claim 1, wherein the metal is deposited on the active substance in a state that the active substance and the metal are in contact without interposition of an oxide therebetween.

3. The electrode material according to claim 1, wherein the metal source compound is any one of an organic metal compound, an organic metal complex, a metal compound containing a carbonate radical, a metal hydroxide, and metal hydroxide peroxide, or a substance obtained by combining the compounds.

4. The electrode material according to claim 1, wherein the metal is any one of nickel, copper, platinum, paradigm, silver, zinc, cobalt, vanadium, tungsten, molybdenum, chromium, and iron, or a mixed material or a metal alloy thereof.

5. An active substance paste for a battery, formed by mixing and dispersing at least an electrode material according to claim 1 and a vehicle.

6. A wet type or all solid-state lithium ion secondary battery, formed using the active substance paste for a battery according to claim 5.

7. A method for producing an electrode material, comprising at least a step of producing primary powder by mixing and dispersing an active substance and a metal source compound, and a step of producing an electrode material by generating a metal from the metal source compound by thermal decomposition of the primary powder and depositing the metal on the active substance, wherein the metal source compound is any one of a metal formate, a metal acetate, a metal compound containing a carbonate radical, a metal hydroxide, and a metal hydroxide peroxide, or a substance obtained by combining the compounds.

8. A method for producing an electrode material, comprising at least a step of producing primary powder by mixing and dispersing an active substance and a metal source compound, and a step of producing an electrode material by generating a metal from the metal source compound by vapor phase reduction of the primary powder and depositing the metal on the active substance, wherein the metal source compound is any one of a metal formate, a metal acetate, a metal compound containing a carbonate radical, a metal hydroxide, and a metal hydroxide peroxide, or a substance obtained by combining the compounds.

9. A method for producing an electrode material, comprising at least a step of producing primary powder by mixing and dispersing an active substance and a metal source compound, a step of producing secondary powder by thermal decomposition of the primary powder, and a step of producing an electrode material by generating a metal from the metal source compound by vapor phase reduction of the secondary powder and depositing the metal on the active substance, wherein the metal source compound is any one of a metal formate, a metal acetate, a metal compound containing a carbonate radical, a metal hydroxide, and a metal hydroxide peroxide, or a substance obtained by combining the compounds.

10. The method for producing an electrode material according to claim 7, wherein the metal source compound is any one of an organic metal compound, an organic metal complex, a metal compound containing a carbonate radical, a metal hydroxide, and a metal hydroxide peroxide, or a substance obtained by combining the compounds.

11. The method for producing an electrode material according to claim 7, wherein the metal comprises any one of nickel, copper, platinum, paradigm, silver, zinc, cobalt, vanadium, tungsten, molybdenum, chromium, and iron, or a mixed material or a metal alloy thereof.

12. The electrode material according to claim 2, wherein the metal source compound is any one of an organic metal compound, an organic metal complex, a metal compound containing a carbonate radical, a metal hydroxide, and metal hydroxide peroxide, or a substance obtained by combining the compounds.

13. The electrode material according to claim 2, wherein the metal is any one of nickel, copper, platinum, paradigm, silver, zinc, cobalt, vanadium, tungsten, molybdenum, chromium, and iron, or a mixed material or a metal alloy thereof.

14. The electrode material according to claim 3, wherein the metal is any one of nickel, copper, platinum, paradigm, silver, zinc, cobalt, vanadium, tungsten, molybdenum, chromium, and iron, or a mixed material or a metal alloy thereof.

15. An active substance paste for a battery, formed by mixing and dispersing at least an electrode material according to claim 2 and a vehicle.

16. An active substance paste for a battery, formed by mixing and dispersing at least an electrode material according to claim 3 and a vehicle.

17. An active substance paste for a battery, formed by mixing and dispersing at least an electrode material according to claim 4 and a vehicle.
